(19) United States
(12) Patent Application Publication
(10) Pub. No.: US 2007/0175085 A1
(43) Pub. Date: Aug. 2, 2007

(54) Combination lamp and insect eliminator

(76) Inventor: Chi-Gon Chen, Guang Zhou (CN)

Correspondence Address: David G. Moore;Strasburger & Price, LLP, Suite 4400, 901 Main St., Dallas, TX, 75202, US

(21) Appl. No.: 11/486,518

(22) Filed: Jul. 13, 2006

Related U.S. Application Data
(60) Provisional application No. 60/764,557, filed on Feb. 2, 2006.

(51) Int. Cl. A01M 1/22; A01M 1/04

(52) U.S. Cl. 43/112; 43/113

(57) ABSTRACT

The invention described in this application is either a rechargeable battery or a solar powered lamp and insect eliminator. The invention includes solar panels, LED bulbs, rechargeable batteries and an insect elimination system. In another embodiment the solar panel is removed and the invention is powered by rechargeable batteries. The insects are electrocuted by the electricity generated by the solar panel or rechargeable battery. Additional, the LED can illuminate dark areas or attract insects to their demise.

### CROSS-REFERENCE TO RELATED APPLICATIONS

This utility patent application makes reference to and seeks the benefit of U.S. Provisional Patent Application No. 60/764,557 filed Feb. 2, 2006.

### STATEMENT REGARDING FEDERALLY SPONSORED RESEARCH OR DEVELOPMENT

The invention described in this application was not the subject of federally sponsored research or development.

### FIELD

The present invention pertains to yard fixtures; more particularly, the present invention pertains to solar-powered and rechargeable battery-powered yard fixtures.

### BACKGROUND

In recent years, there have been improvements in two areas of technology which have progressed on parallel tracks. Specifically, the technology of LEDs has improved to where the amount of illumination provided by an LED has increased. Additionally, the technology of both solar panels and rechargeable batteries has improved to where the amount of available electrical energy has increased. The result of the parallel improvements in these two areas of technology has produced systems where the electrical energy provided by solar panels or rechargeable batteries is sufficient to cause one or more LEDs to illuminate while leaving enough electrical energy to provide power for the operation of other devices which may be used with LEDs.

### SUMMARY

According to the present invention, a fixture designed primarily for use in residential yards includes a solar panel for absorbing light energy and converting the absorbed light energy into electrical energy or a rechargeable battery. The stored electrical energy is then used to power one or more LEDs. In addition, the remaining stored electrical energy obtained from the solar panel or the rechargeable battery is used to provide electrical power to an insect elimination system. Alternatively, the system and method of the present invention may be powered solely by rechargeable batteries. An electrically powered insect elimination system is well known to those of ordinary skill in the art. Typically an electrically powered insect elimination system includes a plurality of uninsulated wires. The electrical energy in the uninsulated wires kills any insect that comes into contact therewith. With conventional non-solar powered insect eliminators, the electrical energy used to power the insect eliminator usually comes from an AC electrical outlet connected to the device by an extension cord.

A combination solar powered or rechargeable battery powered lamp and insect eliminator would be beneficial to users in many ways. First, because it is either solar powered or powered by a rechargeable battery, it may be used anywhere without the necessity of being tethered to a house electrical outlet.

Second, the lamp may be used to illuminate pathways to prevent falls or bring light to dark areas to thwart the activity of intruders.

Third, the insect eliminator will decrease the number of insects in an outdoor or partially enclosed area. Insects such as flies and mosquitoes are not only obnoxious pesky creatures but they can also transmit infectious diseases. These diseases include transmission of microorganisms which may cause gastroenteritis, hepatitis, malaria, meningitis and encephalopathy. An example of a mosquito-borne disease commonly referenced in the lay press is West Nile virus.

### BRIEF DESCRIPTION OF THE DRAWING FIGURES

A better understanding of the combination lamp and insect eliminator of the present invention may be had by reference to the drawing figures, wherein:

FIG. 1 is the front elevational view of the solar powered lamp and insect eliminator, and

FIG. 2 is the front elevational view of the rechargeable battery powered lamp and insect eliminator.

### DESCRIPTION OF THE EMBODIMENTS

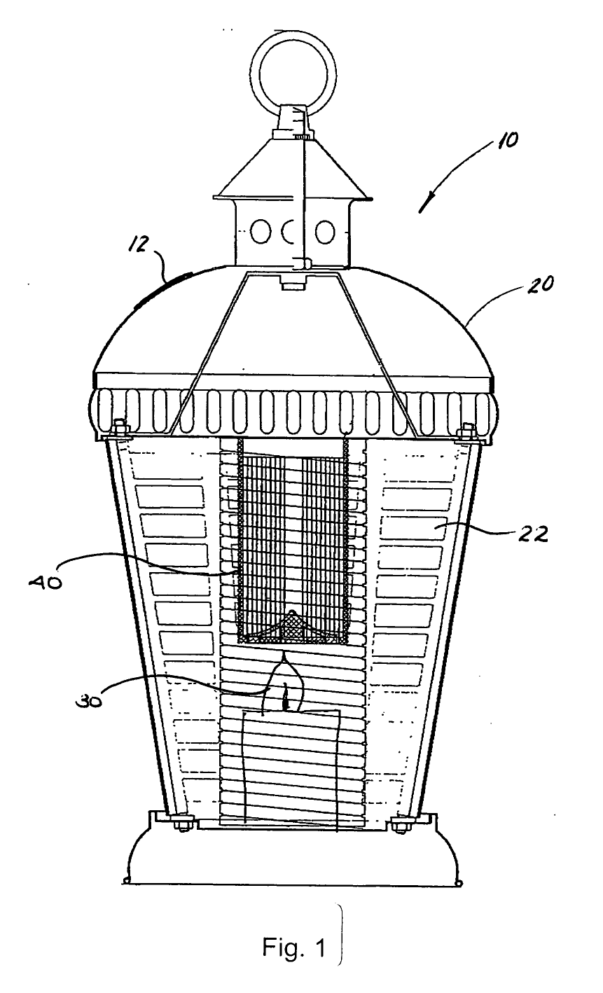

As may be seen in the attached drawing figures, the solar-powered or battery powered lamp and insect eliminator 10 of the present invention is contained within a housing 20. As shown in FIG. 1 one or more solar panels 12 are positioned on top of the housing. The solar panel 12 converts light energy into electrical energy. The electrical energy obtained from the light energy is then passed through an array of electrical components which enable the electrical energy to be stored in a battery (not shown) contained within the housing 20. Such arrays of electrical components are well known to those or ordinary skill in the art. When the stored electrical energy is needed, it is caused to flow from the battery through whatever electrical components (not shown) are needed to transform the electrical energy into the proper voltage and condition so that it can be used to power an LED 30 and an insect-elimination system 40. These electrical components are also well known to those of ordinary skill in the art and are also contained within the housing 20.

As may be seen in the attached drawing FIG. 1 depicting an outdoor yard fixture including the present invention, the housing 20 encloses at least one LED 30 and an insect-elimination system 40. Electrical energy used to power the LED 30 and the insect-elimination system 40 comes from a battery (not shown) and is transformed by electrical components (not shown) into a form that can be used by the LED 30 and the insect-elimination system 40. Accordingly, the LED 30 provides a decorative appearance to the outdoor yard fixture, and the insect elimination system 40 exterminates the insects which fly into contact with the insect-elimination system 40. As a variety of different color LEDs are now available, the LED may be selected from those which have a color and intensity which normally attracts insects.

The housing 20 includes openings 22 which provide an exit for the light from the LED 20 and an entry path for insects. The housing may be hung from a tree or pole or attached to the ground with a stake attached to the underside of the housing.

By use of a switching system well known to those of ordinary skill in the art, the LED and insect elimination system may be operated together or separately.

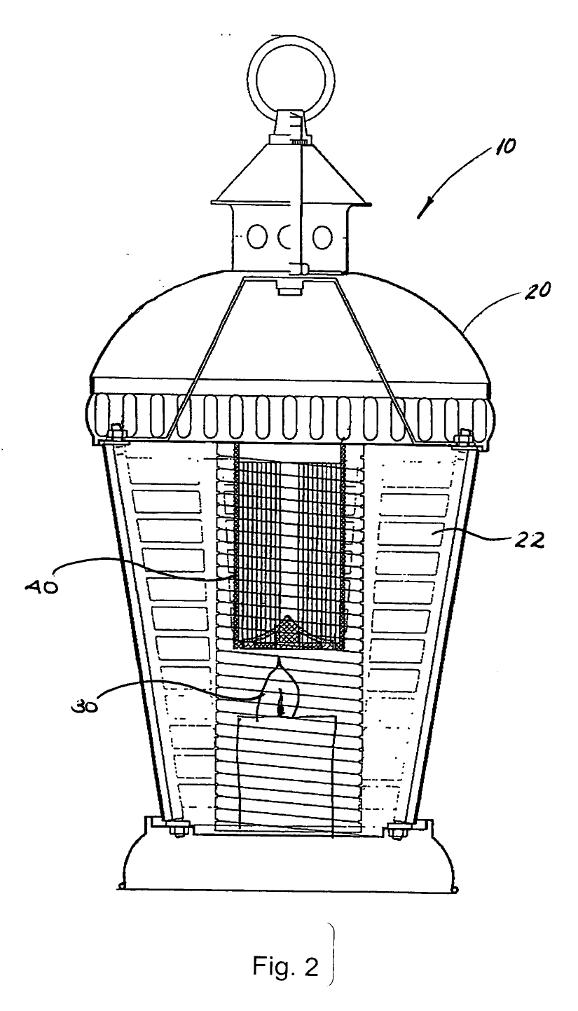

Yet another embodiment as shown in FIG. 2 is made possible by use of rechargeable batteries to power the system including the insect eliminations system 40. In this embodiment of the present invention the solar panels are removed and rechargeable batteries are used to provide electricity to power the system. The use of rechargeable batteries would be most effective in geographic locations which have extended periods of cloud cover or in dark or shady areas around the exterior of the house which do not receive direct sunlight. The ability to use the system and method of the present invention during periods of extended cloud cover or in dark or shady areas would be helpful because that is the time and place when insects would be most active and bothersome. Rechargeable batteries and systems for recharging rechargeable batteries are well known to those of ordinary skill in the art.

While the system and method for the present invention has been described according to the foregoing embodiments, those of ordinary skill in the art will understand that still other embodiments have been enabled by the foregoing disclosure. Such other embodiments shall be included within the scope and meaning of the appended claims.

What is claimed is:

1. An outdoor yard fixture comprising:
a housing;
a solar panel mounted in said housing, said solar panel constructed and arranged to convert light energy into electrical energy;
a battery within said housing for storing the electrical energy obtained from said solar panel;
at least one LED within said housing, which at least one LED illuminates when electrical energy from said battery is properly applied to said LED;
at least one insect-elimination system within said housing, which at least one insect-elimination system which eliminates insects when electrical energy from said battery is applied to said insect-elimination system.

2. The outdoor yard fixture as defined in claim 1 wherein said LED and said insect-elimination system are electrically separable one from another so that said LED and said insect-elimination system may be used separately or together.

3. The outdoor yard fixture as defined in claim 1 wherein said LED is of a particular color so as to attract insects.

4. The outdoor yard fixture as defined in claim 1 wherein said housing has a means for removal of dead insects.

5. The outdoor yard fixture as defined in claim 1 further composed of a means by which said outdoor yard fixture may be suspended from a pole affixed to the ground.

6. The outdoor yard fixture as defined in claim 1 which is further composed of a means by which said outdoor yard fixture may be securely attached to the ground.

7. A method for the extermination of insects comprising:
a solar panel to convert solar energy to electrical energy;
a battery to store the electrical energy;
an LED to emit light of a wavelength to attract insects;
an insect elimination system which eliminates insects with electricity obtained from said solar panel or said battery;
a housing to contain said solar panel, said battery, said LED and said insect elimination system.

8. The method for eliminating insects as defined in claim 7 in which said housing has a means for removal of dead insects.

9. An outdoor yard fixture comprising:
a housing;
a rechargeable battery within said housing for storing electrical energy;
at least one LED within said housing, which at least one LED illuminates when electrical energy from said battery is properly applied to said LED;
at least one insect elimination system within said housing, which at least one insect elimination system, which eliminates insects when electrical energy is received from said battery is applied to said insect elimination system.

10. The outdoor yard fixture as defined in claim 9 wherein said LED and said insect-elimination system are electrically separable one from another so that said LED and said insect-elimination system may be used separately or together.

11. The outdoor yard fixture as defined in claim 9 wherein said LED is of a particular color so as to attract insects.

12. The outdoor yard fixture as defined in claim 9 wherein said housing has a means for removal of dead insects.

13. The outdoor yard fixture as defined in claim 9 further composed of a means by which said outdoor yard fixture may be suspended from a pole affixed to the ground.

14. The outdoor yard fixture as defined in claim 9 which is further composed of a means by which said outdoor yard fixture may be securely attached to the ground.
